(19) United States
(12) Patent Application Publication
(10) Pub. No.: US 2026/0307687 A1
(43) Pub. Date: Oct. 8, 2026

(54) DOOR LEAF WITH UNBONDED SEAL

(71) Applicant: Bode - Die Tür GmbH, Kassel (DE)

(72) Inventors: Ulrich Arend, Dickershausen (DE); Andreas Pellegrini, Edermünde (DE); Diako Rasekhi Coochesfahani, Kassel (DE); Norbert Bauer, Hessisch Lichtenau (DE)

(21) Appl. No.: 19/571,019

(22) Filed: Mar. 18, 2026

(30) Foreign Application Priority Data
Mar. 19, 2025 (DE) 10 2025 110 688.6

(51) Int. Cl. B61D 19/02

(52) U.S. Cl. CPC B61D 19/02

(57) ABSTRACT

The invention relates to a door leaf (20), in particular for a door of a vehicle of public local and long-distance transport. This has
a door frame (1) with frame columns (1.2, 1.3) and door struts (1.1, 1.4, 1.5) as door elements, which have respectively a recess (22) on their inner sides assigning to one another,
at least one seal (2.1, 3.1), which is arranged in the recesses of the frame columns (1.2, 1.3) and door struts (1.1, 1.4, 1.5),
at least one glass pane (2, 3), not bonded with the door frame (1), which is fixed in the door frame (1) via the at least one seal (2.1, 3.1) and the recesses (22).

### CROSS-REFERENCE TO RELATED APPLICATIONS

This application claims the benefit of German patent application no. 10 2025 110 688.6, filed on 19 Mar. 2025, the disclosure of which is incorporated herein by reference in its entirety.

### TECHNICAL FIELD

The disclosure relates to a door leaf with at least one glass pane, in particular for vehicles of public local and long-distance transport.

### BACKGROUND

In the field of door systems, in particular for vehicles of public local and long-distance transport, it is usual to use door leaves with glass panes, in order to both enable a good view for the passengers and also to ensure safety and comfort.

Known systems typically comprise door leaves in which the glass panes are securely connected to the door frame, often by bonding or other permanent fixing methods. These construction methods indeed offer a stable connection and a reliable sealing against external influences such as moisture, dust and noise, but also entail various challenges. In particular, the bonding of the glass panes requires special adhesives and laborious manufacturing processes, which increase both the expenditure of time and also of costs. Moreover, such constructions make repair and maintenance work difficult, as the removing and replacing of damaged glass panes involves considerable effort.

According to the prior art, separate seals are frequently used for sealing between door frame and glass pane, which are either introduced onto the glass pane or into the door frame. These seals serve to guarantee the tightness of the door and to prevent the penetration of water, dust and noise. In known embodiments, the seals are additionally bonded or fixed in another way. Despite the considerable advantages in the field of door systems for vehicles, challenges still exist with regard to the ease of installation, the exchangeability of components and the reduction of manufacturing and maintenance costs. In particular, a need exists for solutions which enable a simpler and quicker installation of the door leaves and, at the same time, ensure a reliable sealing and fixing of the glass pane without being dependent on complex bonding processes.

It is therefore a technical problem as basis of the present disclosure to provide a door system which at least partially overcomes the disadvantages of known systems.

### SUMMARY

The disclosure consists in proposing a door leaf which is constructed in a simple manner and the manufacture of which can take place quickly and economically. In particular, an exchange of the glass pane is to be as simple and as economical as possible. It is also an aspect of the disclosure to propose a method for the manufacture of such a door leaf.

The problem is solved by a door leaf with the features of the independent apparatus claim and a method with the method steps of the independent method claim.

Accordingly, a door leaf is provided which is suitable in particular for doors of vehicles of public local and long-distance transport. This door leaf comprises a door frame, which is formed from frame columns and door struts.

An essential aspect of the disclosure consists in that the glass pane is not bonded in the door frame, but is merely inserted detachably in recesses of the door frame. For this purpose, the door frame has an inner, preferably circumferential recess or respectively groove in the door elements, in which the glass pane is held.

The term “glass pane” is to be understood as a synonym for planar viewing areas, therefore for example also areas of transparent or semi-transparent plastics.

Furthermore, at least one seal is arranged in the recesses, which seal enables a tolerance compensation between the glass pane and the door frame and, at the same time, ensures the sealing of the recesses outwards. The at least one glass pane is fixed in the door frame in an unbonded manner via the seal and the recesses.

The seal therefore fulfils several functions: On the one hand, the seal enables a tolerance compensation between the glass pane and the components of the door frame, so that manufacturing tolerances or dimensional deviations can be compensated. On the other hand, the circumferential seal provides for a reliable sealing of the joint between pane and frame with respect to moisture, dust and noise, which is important in particular in the use in vehicles of public local and long-distance transport, for example with regard to fulfilling design, heat and sound insulation requirements.

Via an adaptation of the dimensions of the recesses or respectively grooves and/or of the seal, the construction can be adapted to various types of pane, such as for example double glazing or insulating glass.

The dispensing with the bonding is advantageous not only with regard to the quicker and simpler installation, but also therefore because the environmental compatibility of adhesives is often problematic. Added to this is that their adhesive strength can weaken with time, therefore over the service life of the vehicle.

A further advantage lies in the possibility of being able to exchange the glass pane, in the event of repair, quickly and in a non-complicated manner, without the entire door leaf having to be removed from the vehicle; it can already be sufficient to only dismantle a single frame column in order to be able to extract the glass pane from the door frame.

In the finished assembled state of the door leaf, the door struts and frame columns are securely connected to one another. Advantageously, the connection thereof takes place via screws, as these are detachable and thus an exchange of the glass pane, for example due to damage or breakage, can take place quickly and simply. Basically, however, other suitable detachable connections can also be used. For example, a snap connection with elastic detent noses which in the assembled state of the door leaf project into corresponding detent openings or depressions and are held there, are conceivable. The door leaf can thereby be manufactured quickly and simply by connecting together; for detaching, the detent noses merely have to be brought out of engagement with the holding faces of the detent openings, for example by shifting the detent noses.

In a particularly advantageous variant embodiment, only one door element has a detent connection with the other door elements. Three door elements are, for example, screwed to one another, the glass pane is introduced via its side edges between these three door elements in such a way that it extends into the internal recesses. The term “side edge” refers here to the vertical and horizontal edges of the glass pane. Subsequently, the last door element is mounted quickly and simply by means of a detent connection. An exchange of the glass pane then takes place likewise only by releasing the door element which was inserted via the detent connection and by extracting the glass pane.

Preferably, a single circumferential seal extends along the side edges of the glass pane, whereby a continuous mount and seal between the glass pane and the door frame is created. The term “circumferential seal” designates here a sealing element which surrounds the entire periphery of the glass pane and thus lies against all side edges of the pane. This seal is received in the recesses of the frame columns and door struts provided for this, so that the glass pane is fixed in the door frame via the seal and the recesses.

The use of a single, circumferential seal simplifies the assembly considerably, as several separate seals do not have to be positioned and aligned on different sides of the pane; instead, the seal can already be applied onto the glass pane for example before the assembly, which facilitates the handling and reduces the risk of assembly errors. A further advantage lies in the reduction of the multiplicity of parts and of the storage costs associated therewith, as only one seal is required for the entire pane. Furthermore, through the circumferential configuration of the seal, a uniform pressure distribution is achieved along the entire edge of the glass pane, which reduces the risk of tensions or localized stresses and thus minimizes the risk of glass breakage or leaks.

In the event of repair, the glass pane with the circumferential seal can be simply removed from the door frame and replaced, without laborious bonding or clamping work being necessary, which reduces the maintenance costs and the downtimes of the vehicle. In addition, the circumferential seal contributes to all components of the door leaf, such as door struts and frame columns, being able to be coated or coloured already before installation, as no subsequent bonding of the pane is necessary, which enables an improved corrosion protection and the implementation of individual colour schemes.

As a whole, through the use of a single circumferential seal, a solution is provided which is structurally simple, easy to install and with low maintenance for the fixing and sealing of glass panes in door leaves of public transport vehicles, which is distinguished in particular by its flexibility with regard to different types of pane and design requirements.

The disclosure is suitable in particular for sliding doors, swing doors or swing-/sliding doors. Only a single continuous glass pane may be provided in the door frame, but also several glass panes, in particular two glass panes may be present, which for example are separated by a middle door strut.

According to a variant embodiment, a special seal arrangement is provided along the side edges of the glass pane. A first seal extends along three side edges of the glass pane, and a second seal along the remaining side edge. The terms “first seal” and “second seal” refer here to seal portions which are distinguishable from one another, which respectively surround different regions of the glass pane. The first seal, which covers three side edges, can be configured for example as a cohesive, one-piece seal, which ensures a continuous sealing and a tolerance compensation between pane and frame. The second seal along the remaining side edge can be adapted specifically in order to fulfil particular requirements for sealing, installation or exchangeability, for instance by having a different material characteristic, geometry or type of fastening.

Through this differentiated seal arrangement, a targeted sealing and fixing of the glass pane is achieved, wherein in particular at the remaining side edge additional functions can be realized, such as a facilitated dismantling, improved ease of repair or an optimized sealing with respect to moisture and sound. Furthermore, the separation into a first and a second seal can contribute to different loads or movements of the door leaf being compensated better, for instance when a side edge is to be exposed to particular mechanical or thermal influences. As a whole, this embodiment contributes to increasing the functionality, ease of maintenance and lifespan of the door leaf, by the seal arrangement being able to be configured in a flexible and customized manner.

However, an arrangement of respectively one individual seal per side edge of the glass pane can also have advantages. For example, thereby a sealing, targeted and independent of one another, of the respective edge of the glass pane with respect to the door frame is possible. Also, a particularly effective tolerance compensation between the glass pane and the door frame can be achieved, as each seal can react to manufacturing tolerances and dimensional deviations independently, which is important in particular with regard to the requirements for tightness, sound insulation and thermal insulation in door leaves for vehicles of public local and long-distance transport. Also, the installation and dismantling of the glass pane are, if applicable, simpler, because the seals are mounted on the relevant edges in a targeted manner, and can be exchanged individually if required, without a complete dismantling of the entire seal system being necessary. In addition, through the separation of the seals at the individual side edges, an improved adaptability to different pane geometries and frame embodiments is achieved, which increases the flexibility in the construction and in the use of various glass pane types, such as for example single glazing or insulating glass. In the event of damage to a seal, also only the seal concerned on the respective side edge has to be replaced.

A method for the production of a door frame according to the disclosure has the following method steps:
connecting of a maximum of three door elements from the group of frame columns and door struts for the formation of an assembly door frame,
connecting of at least one seal with circumferential side edges at least of one glass pane,
inserting the glass pane into the assembly door frame, dispensing with a bonding,
connecting the or remaining door elements to the assembly door frame for the formation of the door frame.

Alternatively, the door elements can be firstly provided with seals, before they are connected to the assembly door frame or respectively door frame. The seal or the seals are then therefore not connected with the glass pane before the assembly, but rather with the door elements or respectively already introduced into the recesses.

### BRIEF DESCRIPTION OF THE DRAWINGS

The disclosure is explained more closely with the aid of the following figures. In the figures, only one example embodiment of the disclosure is shown, which is intended to explain the essential aspects of the disclosure.

There are shown:

FIG. 1 shows a fully assembled door leaf according to the disclosure with glass panes,

FIG. 2 shows an exploded view of the door leaf,

FIG. 3 shows the door leaf in cross-section.

FIG. 1 shows a fully assembled door leaf 20, with a door frame 1 and two glass panes 2,3.

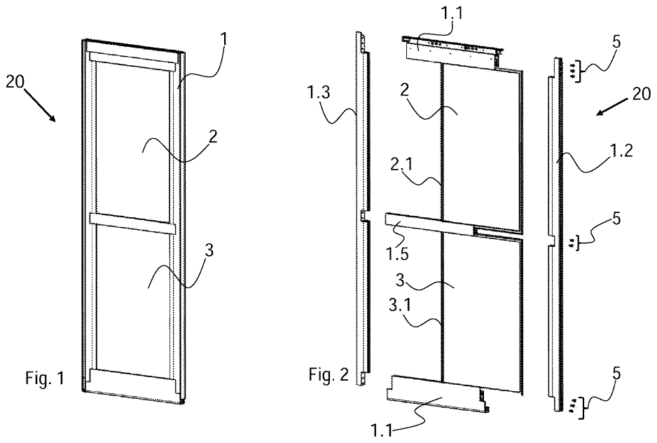

In FIG. 2 the door leaf 20 is to be seen in an exploded view with the following components:
1.1 door strut top
1.2 frame column right
1.3 frame column left
1.4 door strut bottom
1.5 door strut middle
2 and 3 glass panes
2.1 and 3.1 seal of the glass panes
5 screws

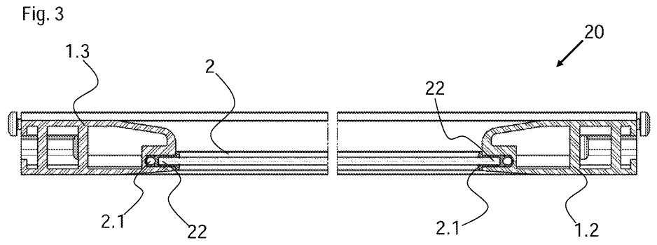

FIG. 3 shows a cross-section of the door leaf 20.

### DETAILED DESCRIPTION OF THE DRAWINGS

As can be readily seen, the glass panes 2,3 are provided respectively with a circumferential seal 2.1, 3.1.

Already during the installation of the door frame, the glass panes 2,3 are inserted into a corresponding recess 22 in the door struts 1.1, 1.4, 1.5 and frame columns 1.2, 1.3. The seals 2.1, 3.1 ensure a tolerance compensation between glass pane 2, 3 and door frame 1, and a sealing of the recesses 22.

It is possible to use single glazing, double glazing or insulating glass panes. For this, the recesses 22 in the door struts 1.1, 1.4, 1.5 and frame columns 1.2, 1.3 are to be adapted.

It is also possible, instead of one of the glass panes 2, 3, to use a sandwich structure of e.g. metal sheets with a foam core, in order to implement design requirements, or respectively to improve thermal and sound insulation.

A further advantage exists in the event of repair: in the case of a defect or fracture of a glass pane 2, 3, only one of the door elements is to be dismantled, in order to insert a new glass pane 2, 3. Here, the door leaf 20 can remain mounted on the vehicle.

FIGS. 1 and 2 show an embodiment of a door leaf for rail vehicles in a front view. The construction comprises a door frame 1, which is configured as a circumferential structure and forms the mechanical basis for receiving glass panes 2. In the example embodiment which is shown, the door frame 1 is embodied as a rectangular frame and consists of the frame elements, upper door strut 1.1, lower door strut 1.4, middle door strut 1.5 and right frame column 1.2 and left frame column 1.3.

Within the door frame 1 in the example embodiment which is shown, two separate glass panes 2 and 3 are inserted. The glass panes 2, 3 are respectively embodied in a planar and rectangular manner, and extend over the width of the door frame, wherein they are separated from one another by the centrally arranged door strut 1.5. The glass panes 2 and 3 are positioned so that they are received in recesses 22 within the door frame 1. The recesses 22 are provided in the frame columns 1.2, 1.3 and door struts 1.1, 1.4, 1.5 and also serve to receive the seals 2.1, 3.1 and for the fixing of the glass panes 2, 3.

The circumferential seals 2.1, 3.1 are arranged between the respective glass pane 2,3 and the adjoining region of the frame columns 1.2, 1.3 and door struts 1.1, 1.4, 1.5. The seals 2.1, 3.1 ensure a tolerance compensation between the respective glass pane 2,3 and the door frame 1 and ensure the sealing of the recesses 22. The glass panes 2,3 are fixed in the door frame 1, without bonding or laborious clamping, directly via the seal 2.1, 3.1 and the recesses 22. The fixing takes place mechanically through the assembly of the frame elements, wherein the glass panes 2, 3 are inserted into the recesses 22 during the assembly of the door frame 1.

The construction of the door leaf 20 also enables a simple dismantling in the event of repair, as in the case of a defect or fracture of a glass pane 2,3, only one of the door-or frame elements, preferably one of the frame columns 1.2, 1.3 has to be dismantled, in order to be able to exchange the glass pane 2, 3 concerned. The door leaf 20 can remain mounted here on the vehicle.

The embodiment permits in addition the use of double glazing or insulating glass panes, wherein the recesses 22 in the frame columns 1.2, 1.3 and door struts 1.1, 1.4, 1.5 are then adapted accordingly. Alternatively, instead of the lower glass pane 3, a sandwich structure, for example consisting of metal sheets with a foam core, can be used, in order to improve design requirements and thermal and sound insulation.

The entire construction is designed to be able to coat all components before the assembling, in order to fulfil corrosion protection and colour requirements. The connection of the door elements takes place for example by means of screws, which ensure a stable and permanent connection.

The exploded view in FIG. 2 illustrates that the glass panes 2 and 3 are entirely bordered by the frame columns 1.2, 1.3 and door struts 1.1, 1.4, 1.5, wherein the seals 2.1 and 3.1 run along the entire side edges of the respective pane. The frame columns 1.2, 1.3 and the door struts 1.1, 1.4, 1.5 are embodied so that they can be respectively screwed to the adjacent elements. In the embodiment according to FIG. 2, the screws 5 are respectively arranged at the connection sites of the frame elements, and serve for the mechanical fastening of the entire frame structure. Instead of screws 5, of course other suitable connecting means can also be selected.

The exploded view enables a clear allocation of the individual components and their assembly sequence. Firstly, the glass panes 2 and 3 are provided with the seals 2.1 and 3.1 and are inserted into the recesses of frame columns 1.2, 1.3 and door struts 1.1, 1.4, 1.5. Subsequently, the connecting takes place of the frame elements by means of the screws 5, whereby the door frame 1 is entirely closed and the glass panes 2, 3 are fixed. The middle door strut 1.5 separates the two glass panes 2, 3 from one another and is screwed to the adjacent frame columns 1.2, 1.3.

FIG. 3 shows a horizontal cross-section through the door leaf 20 in the region of the upper glass pane 2, wherein the essential components and the integration thereof are clearly illustrated. The left frame column 1.3 and the right frame column 1.2 can be seen, which are respectively embodied as profiled, cavity-like structural elements. The frame columns 1.2, 1.3 have recesses 22 for receiving the glass pane 2 and the associated seal 2.1.

The glass pane 2 is arranged centrally in the door leaf and extends between the two frame columns 1.2, 1.3, the glass pane 2 is not bonded, but rather is held mechanically in the door frame 1 by the seal 2.1. The seal 2.1 is embodied as a circumferential profile and is situated between the glass pane 2 and the adjoining surfaces of the frame columns 1.2, 1.3. The seal 2.1 ensures the tolerance compensation and the reliable sealing of the interface between glass pane 2 and the frame columns 1.2, 1.3. The seal 2.1 is dimensioned so that it covers the entire side edge of the glass pane and engages into the recess 22 of the frame columns 1.2, 1.3.

The frame columns 1.2 and 1.3 are embodied as extruded profiles with several chambers and reinforcement ribs, in order to enable a high mechanical stability and an effective mount of the glass pane. The profiles are configured so that they provide a defined installation position for the seals 2.1, 3.1 and the glass panes 2, 3. The sectional illustration shows that the seal 2.1 is guided in a groove within the frame columns 1.2, 1.3, whereby a form-fitting and tight connection is produced.

1. A door leaf, for a door of a vehicle of public local and long-distance transport, the door leaf comprising:
a door frame with frame columns and door struts as door elements, which have respectively a recess on their inner sides assigning to one another;, at least one seal, which is arranged in the recesses of the frame columns and door struts; and
at least one glass pane, not bonded with the door frame, which is fixed in the door frame via the at least one seal and the recesses.

2. The door leaf according to claim 1, wherein a single circumferential seal extends along side edges of the glass pane.

3. The door leaf according to claim 1, wherein a first seal extends along three side edges of the glass pane, and a second seal, extends along the remaining side edge of the glass pane.

4. The door leaf according to claim 1, wherein an individual seal provided respectively at each side edge of the glass pane.

5. The door leaf according to claim 1, wherein at least one of the door elements is connected to adjoining door elements via a detent connection.

6. A method for the manufacture of a door leaf according to claim 1, the method including the following steps:
connecting of a maximum of three door elements from the group of frame columns and door struts for the formation of an assembly door frame,
connecting of at least one seal with circumferential side edges at least of one glass pane,
inserting the glass pane in the assembly frame, dispensing with a bonding, and
connecting the or remaining door elements to the assembly frame for the formation of the door frame.

7. The method according to claim 6, wherein the method step of inserting the seal into the door elements takes place before the forming of the assembly frame.

8. The method according to claim 6, wherein a subsequent dismantling of the glass pane takes place through the following method steps:
dismantling of at least one door element, and
extracting the glass pane from the remaining door elements.

9. The method according to claim 8, wherein a subsequent mounting of a glass pane takes place through the following method steps:
inserting the glass pane into the remaining door elements, dispensing with a bonding, and
connecting the dismantled or another door element to the assembly frame for the formation of the complete door frame.

10. The method according to claim 6, wherein the door leaf remains on the vehicle during the carrying out of the method.
